(19) United States
(12) Patent Application Publication
(10) Pub. No.: US 2010/0205045 A1
(43) Pub. Date: Aug. 12, 2010

(54) System and method for improving retail store customer loyalty

(76) Inventors: Yinying Zhang, Pleasanton, CA (US); Daxing Ren, Pleasanton, CA (US)

Correspondence Address: Yinying Zhang, Suite 186, 2843 Hopyard Road, Pleasanton, CA, 94588, US

(21) Appl. No.: 12/658,276

(22) Filed: Feb. 5, 2010

Related U.S. Application Data
(60) Provisional application No. 61/206,847, filed on Feb. 6, 2009.

(51) Int. Cl. G06Q 30/00; G06Q 10/00; G06Q 99/00; G06F 3/01

(52) U.S. Cl. 705/10; 705/14.25; 705/14.36; 705/27; 705/323; 705/346; 715/747

(57) ABSTRACT

A system and method for improving and maintaining retail store customer loyalty through providing customers with quality services, timely assistances, and conveniences in all stages of product shopping. The system provides a web parts based collaborative online platform for retailers, product manufacturers, and service providers to share resources, distribute coupons, promote products and services, and communicate with customers. It further provides shopping assistances to help customers selectively receive coupons, redeem coupons online, build shopping lists online, retrieve shopping list and shopping reminders, find product shelf locations, place online orders, and manage budgets and nutrition. The system has the capability to collect customer shopping activity data, automatically analyze customer product purchase preferences, recommend products and services, and deliver relevant coupons and advertisements to customers.

### BACKGROUND OF THE INVENTION

The present invention discloses a system and methods for retail stores to improve customer loyalty through an online platform that can provide systematic shopping assistances and life quality enhancement services to customers.

Most retail stores have very low profit margins. Retaining a large customer base is vital to a retail store. The stability of customer base is directly impacted by customer loyalty. If a retail store has a deteriorating customer loyalty situation, its customer base can quickly decrease, meaning many of the current customers will switch to competitors' stores in the near future. The profits of the store will decrease over time.

Customer loyalty is commonly measured by customer churn rate. The higher the churn rate of a store has, the lower the customer loyalty of the store's customers. In order to retain customers, many techniques have been used, such as discount coupons, store incentive programs offering member discounts, and reward cards that encouraging customers to buy more through rewarding back certain percentages. Although retailers and their marketers have more and more sophisticated tools to reaching customers, the customer churn rate is unfortunately rising in general.

Another measurement of customer loyalty is the share of wallet. In the retail industry, especially in the grocery retailing, a customer may split spending in several similar stores. Each store may only get a small percentage of the customer's total spending. In order to increase the sales, a store needs to increase the customer's share of wallet.

The challenges in retaining customers and maximizing share of wallet in current market are that there are more and more shopping alternatives and product varieties in the marketplace. Consumers can get comparative pricing information online before going to a store. Consumers can search for discount deals before making final purchase decisions. Nowadays, the keys to increase customer loyalty are to better understand customers and provide them the products they want, the quality matching their lifestyle, the price competitive to other stores, and the services surpassing their expectation.

Unfortunately, one of the top problems to most retailers is that they lack a good understanding of their customers. For example, most stores are still relying on traditional coupon distribution marketing methods to attract customers. They blindly distribute paper coupons to customers in hope to use price discounts to attract more customers. In fact, such strategy could only generate as little as 1.3% average coupon response rate. In comparison, some retailers can generate over 20% coupon response rate by targeted coupon distribution. Well planned targeted coupons can even generate response rates over 50%. One of the major reasons that the blind coupon distribution generates very low response rate is that the distributed coupons are not relevant to most of the customers.

With the advances in information technologies, it is now possible to extract customer product purchase preferences from customers' shopping baskets for better understanding of customer needs. With widely available internet access, it is a reality for retailers to communicate with customers instantly from anywhere at any time. With the popular use of smart phones and other portable mobile devices, it is now possible to deliver store map and product information directly to the hands of the customers to help them find the products they want to buy without additional in-store hardware investment. The inventors of the present invention recognized that many of the advanced technologies have not been integrated into retail management systems, in particular, not utilized to help retail stores improve customer loyalty.

The inventors of the present invention also recognized that in order to develop strong customer loyalty, stores need to adopt new technologies to provide customers more shopping assistances to improve shopping experience. Such new shopping assistances may include searching for products, locating product shelf locations, retrieving shopping list, and checking reminders while customer are doing in-store shopping.

The inventors of the present invention further recognized that traditional shopping experience is narrowly referred as experience during in-store shopping. In fact, most shopping activities start from the in-home planning stage. Therefore, stores need to provide shopping assistance from the early stage of a shopping cycle. For example, stores should provide online shopping list builder to help customers to develop optimal shopping plans. Customer specific coupons and incentive offers should be available to the customers when customers are making their shopping plans. If a customer wants to use the coupons, the customer should be able to redeem them online right from home.

In addition, stores should provide customers with product consumption guidance, health and nutrition information, household management assistance, communication channels, and other benefits to attract new customers and retain existing customers for improving customer loyalty.

The inventors of the present invention also recognized that a single store may not be capable of providing all products and services to meet customers' diverse needs of daily life. It is more desirable for a retailer to form an alliance with complimentary retailers and services providers to provide customers with the products and services they need. This one-stop-shop solution will give the customers more choices, more convenience, and more money saving opportunities. The shopping will be more predictable, more relaxed, and more enjoyable. If the stores of an alliance can provide customers the most products and services, the customers will be less likely to search around for products and services they need in everyday life. The customers will become more dependent on the stores of the alliance. As a result, customers will be more loyal to the stores.

### SUMMARY OF THE INVENTION

The primary objective of the present invention is to provide a system that can facilitate online information retrieval, online shopping planning, online shopping, online coupon and incentive distribution, and online product advertisement distribution all within one system. Such a system can help retail stores better serve customers by providing more relevant products and services. The system can help improve customer shopping experience by providing customers with online tools for making shopping lists, collecting and redeeming coupons, retrieving shopping lists and reminders, and locating product shelf locations. The system can further help improve customer relationship by providing other online tools for customers to manage household nutrition and budget, schedule events and activities, and enjoy entertainment. It can further help product manufacturers and service providers to reach customers directly and deliver relevant discount coupons and advertisements to customers. In return, it will help retailers improve customer loyalty to the participating retail stores.

The inventors of the present invention recognized that many customers go frustrated during in-store shopping because they could not locate the products they want to buy. The system of the present invention provides several in-store shopping aids at the most wanted time to help customers to locate their products.

One shopping aid is to provide multiple user interfaces for customers to log in to the system wirelessly from their mobile devices. Customers can directly access the system wirelessly to search for products and product shelf locations in either visual map or text formats through internet connections. The visual map will display product shelf locations according to the product shelf location coordinates stored in the system data storage database. The visual map will be dynamically generated through ASP.NET web pages. In the event the customer receiving device cannot display the visual map, the system will respond with text only web page to list the locations of relevant products. Such page format switch can be automatically achieved through JAVA coding or through customer initiation by using different page addresses. The relevant products can be from customers shopping lists, reminders, or search results. For example, when a customer retrieves his or her shopping list through a web page capable smart phone, the system will respond with a store floor map marked with the product locations. The customer can further interact with the map to get additional information.

In some cases, customers may not have access to the internet. An alternative text message format can be provided to the customers through short message service (SMS). Customers can use SMS-capable mobile phones to call into the system to retrieve or search product shelf location information by text messages.

A further aid is to provide a voice enabled web interface to allow customers to use cell phones to search products and product shelf locations. When a customer calls in through a cell phone or any type of calling device, the system can respond to the voice of the customer to guide the customer to identify the products. Once a product is identified, the system can provide product locations by voice. For example, if the customer wants to check his or her shopping list, the system will respond with voice narrating the products in the shopping list along with product shelf locations. Such voice enabled web applications can be accommodated by incorporating a voice server with a web application server. For example, Microsoft and IBM both provide servers for such voice enable web services.

To aid customer to access the system, product search guide along with call-in numbers and a web addresses can be placed at noticeable shelf locations within the retail stores. Preferably, multiple communication devices are to be installed at strategic locations inside a store to help customers in product search. The communication devices can be any type of device that has the capabilities to communicate with the system through connections of intranet or internet, and interactively respond to customer input. For example, a touch screen device connected to a local computer would be sufficient while dedicated kiosks are preferred.

Besides providing in-store shopping assistances, this system also provides shopping aids at the shopping planning stage. Through the interne, the system provides shopping preparation tools to allow customers to prepare shopping in their homes. In fact, customers can access the system anywhere and anytime once they can connect to interne or dial in through voice connection. The shopping planning tools may include shopping planner, online coupon box, and nutrition and budget managers. Many other tools can also be provided to help customers make shopping plans such as shopping reminders and family event planner. Such shopping planning assistances will make the whole shopping task easier, and can help customers save money and improve quality of life. In return, customers will be more dependent on the system for their shopping and be more loyal to the retailer store.

A further objective of the present invention is to provide a system that enables retail stores to provide personalize shopping assistance tools to their customers. In order to achieve this objective, the present invention takes the advantages of currently available web part functionality to build customer shopping assistance tools in individual web parts to allow customers to freely select the web parts and place them in personalized user interfaces.

For example, the system provides a number of web parts for store customers to make shopping list, collect and redeem coupons, find product shelf locations during in-store shopping, place online orders, and manage household budgets.

The web parts can be either listed in the web part catalog section of each page or listed in a library in separate page or pages. Customers can select the web parts from the catalog or library and add them into their pages. Customers can also freely remove the web parts when they are no longer needed. Customers can choose or set the format, appearance, and information scopes to control what they want to see, what they want to receive, and what they want to participate in. Such user configurable features can empower customers to have total control over their online activities so that the customers can feel more respected and more secure. Thus, a better customer relationship can be developed.

The system gives customer users the options to set up one or more home pages to showcase their personal favorites. Customer users can configure which page or pages can be publicly accessible. Customer users can restrict a page's access by configuring a page's access restrictions, such as to set a page to be publicly accessible or allow only a specific user group to access. Users can have records of who visited their home pages. Visitors can sign in the guest book at a home page so that the owner of the home page knows if the visitor would like to be in touch.

Several users may share one user account, such as members of a family may share the same account for family grocery shopping and household management. Users can log on to the system by unique user ID. Such ID can be a membership card number, a phone number, an email address, a residential address, or a user name. A user name associated with a membership card number is preferred for identifying a customer.

Similarly, store management web parts will be provided to store or retailer administration users to manage products, online sales, promotion, and other retail management activities. Supplier web parts will be provided for product manufacturer and service provider administration users to manage products, advertisement, promotion, coupon distribution and other activities.

All users can use a same user interface for login. Once a user has logged in, the system can provide the suitable web parts for the user according to the user's role and scope associated with the user account. Users can personalize their interfaces by selecting, arranging, and configuring the web parts.

Security features can be added for some of the web parts in order to handle sensitive materials like shopping budget and health information. It is common that such a store shopping account is normally shared by family members. It is necessary to provide additional security features within an account. For example, parents may allow underage children to make grocery product selection but do not want them to get into shopping budget web part. In this case, the parent can activate the security lock on the shopping budget web part to prevent children from access this information.

Each web part can have at least one security lock. Primary account owner can set a unique key (a password) for each web part. For the convenience of use, the primary owner may also set a master key for all web parts. The primary account owner can give out the unique key to family members to access the security enabled web parts. The advantage of having such master and member security key features is that it encourages family members to share an account for family grocery product purchasing and household management, which will be more accurate in reflecting the whole household product consumption pattern. In return, the retail store can provide better services to the family.

A further objective of the present invention is to provide tools to help retail stores better understand customers. To achieve this objective, the present invention takes the advantages of available data management tools to store customer shopping data in version controlled format. The present invention further takes the advantages of database automatic data processing capability to develop procedures that can extract and analyze customers' shopping data to automatically generate and update customer product purchase preference profiles.

Customer product purchase preference profiles can help retailers to better manage products, optimize product prices, plan more effective promotions, and selectively offer incentives to the customers. The profiles can also be used for automatic product recommendation and targeted advertisement delivery.

To build a multiple dimensional customer product purchase preference profile for each customer, the web parts can be purposely designed to suit different lifestyles. A customer's selection of the web parts can reflect the lifestyle of the customer.

For example, if a customer has selected a cooking instruction web part and uses it frequently, it is likely this customer likes cooking. If the customer always purchases raw food and cooking ingredients, it is fairly certain this customer likes cooking in home. Thus, this customer can be assigned into a family cooking group.

Within the web parts, user configurable settings will further define a customer's personal preferences. For example, in the coupon boxes, if a customer selects to accept certain ethnic product coupons, it is most likely that the customer belongs to that ethnic group.

It should be understand that a customer referred in this disclosure is not necessary a single person. It can be a household of multiple person family. The customer product purchase preference profile is designed to represent the lifestyle of the whole family.

An advantage of using a multiple dimensional customer product purchase preference profile to characterize a customer is that it is no longer necessary to do a customer survey or ask the customer to fill out a lengthy customer profile form. The system will extract and analyze the customer's lifestyle and product preference from the selected web parts and web part settings initially. The system will further refine a customer's product purchase preference profile when the customer involves in more shopping activities.

To refine or update a customer's product purchase preference profile, the system uses automatic procedures to analyze the customer's shopping activity data from shopping lists, product purchase behaviors, coupon selection and redemption, responses to promotion offers and advertisements, and other online activities.

For example, the system will utilize the version controlled data files to analyze what a customer wanted and what the customer actually purchased through comparing products in different versions of shopping lists with the products actually purchased to reveal why the customer changed mind and what factors influenced the purchase decisions.

To capture a customer's shopping decision making process in version controlled data files, the shopping planning user interface can suggest the customer to save the list after the customer completes building a shopping list. If the user does so, a new version of the shopping list is saved. If the customer does not save the shopping list, the system can guide the customer to refine or update the shopping list. The system can be configured such that during page transfer, the shopping list is saved before proceeding to the next step.

Another approach is that whenever a customer adds a product to the shopping list, a time stamp is placed along with the product. When the customer removes a product, the product can be simply removed from the shopping list while the system still maintains a record when the product was added and removed.

Similarly, customer's response to an advertisement or a promotion offer can be captured and analyzed. For example, during the shopping list refining and updating steps, the system can offer promotional items to the customer. If the customer accepts the offers, the time between the offers and the acceptances can be analyzed for effectiveness of the offers.

In order to compare customers' product purchase preferences, one can use a multiple dimensional score system to characterize customers' product purchase preferences.

To constructing a customer's product purchase preference profile, one can follow the steps of: (a) defining multi-dimensional metrics presenting product price level, customer lifestyle, and product purchase decision making behavior; (b) defining a scale for each dimension of the metrics; (c) assigning a score for each level of the scale; (d) assigning scores for each dimension of each product, each customer preference setting parameter, and each customer product purchase decision making behavior based on predefined rules; (e) building a multi-dimensional metric data set corresponding to the multi-dimensional metrics for each customer according to customer's purchased products, web part settings, and product purchase decision making behavior, (e) adding the scores of each product, each customer preference setting parameter, and each customer product purchase decision making behavior to each corresponding dimensions of the multi-dimensional metric data set, and finally (f) averaging the scores of each dimension of the data set for the customer, (g) saving the average scores of each dimension of the multi-dimensional metric data set as the customer's product purchase preference profile.

The multi-dimensional metrics for building customer product purchase preference profiles can be as simple as having only a few dimensions, or as sophisticated as having a few thousand dimensions. For practical use, 20 to 100 dimensions are preferred.

The levels of each dimension may be different. For example, customers may be divided into only 2 groups according to their smoking status: smoking and non-smoking. Thus, for the smoking status dimension, there will be only 2 levels. One can assign a score of 0 to non-smoking customers and 1 to the smoking customers. In other dimensions, more levels may be needed. For example, customer spending style could be divided into 10 levels to represent monthly spending at a store from 0 to 200 dollars, with each level having $20 difference.

A rule or guideline should be established for assigning scores to each dimension of a product or a product purchase decision making behavior, such as the 2 levels for smoking status and 10 levels for spending style.

The customer product purchase preference profile construction procedures are carried out by a customer product purchase preference data analysis system which comprises stored procedures and data tables. The procedures can be configured to run at scheduled time or run dynamically responding to customer shopping data input. It is preferred to run at scheduled time to reduce workload of the database server.

Once each customer's product purchase preference profile is built, one can segment the customers into different groups according to their scores in each dimension. Such customer segmentation can be used for customized coupon delivery, targeted promotion offering, or relevant advertisement delivery.

To apply the customer product purchase preference profile for customized coupon delivery, one can follow the steps of: (a) assigning a score for each dimension of the multi-dimensional metrics for the product of the coupon according predefined rules, (b) defining priorities for the types of targeted customer segments, (c) defining a threshold for each dimension of the priorities of the multi-dimensional metrics that either accepts or rejects a match between a coupon and a customer, (d) extracting the matched customers as candidates for the coupon delivery, (e) rejecting those candidates whose coupon box web part settings have specific selection for declining that type of products, and finally (f) adding the remaining candidates into the coupon distribution list.

For example, if a coupon is for promoting a premium steak, it would be obvious that the targeted customer segment will be the customers with high spending levels. However, some of the customers with high spending levels may be vegetarians. Therefore these customers should be removed from the pool of coupon distribution candidates.

The customer product purchase profiles can be visualized in a web page through web part by multidimensional charting tools available commercially to help retailers better understand customers' product purchase preference and to develop better marketing strategies and customer services.

### DETAILED DESCRIPTION OF THE INVENTION

In order to meet customers' diverse lifestyles, the system provides various web parts with specific functions for customers to choose. Some of the web parts will be described in more detail.

For helping customers better utilize coupons, the system provides one general coupon box and one or more user configurable coupon boxes. The general coupon box will receive and maintain all coupons distributed by the retailer, product manufacturers, or service providers. Those coupons may be universally distributed to all customers. As a result, the number of coupons in a customer's general coupon box could grow rapidly, and most of them may not relevant to the customer. While such coupon delivery strategy still has some value, it is known to be ineffective because it is difficult for customers to find the relevant coupons. To improve the effectiveness of coupons, the system provides user configurable coupon boxes to allow customers to selectively receive and store coupons they want.

The coupon boxes are provided to customers through coupon box web parts. Each coupon box web part can have at least one coupon box. Customers can add one or more user configurable coupon box web parts into his or her user interface pages. Customers can configure the coupon boxes to receive different type of coupons. Customers can drag and drop coupons from one box into another. A customer can opt to have a number of user configurable coupon boxes to receive and store different types of coupons for later use. The system will automatically deliver coupons into the user configurable coupon boxes according to coupon box sittings, or configurations and the customer's product purchase preference profile. Coupons in any type of the boxes may be automatically removed once they are expired unless the customer has marked them to be kept in the box. The system will maintain a record of all delivered and redeemed coupons for market analysis and development.

Furthermore, the system provides one general incentive offer container web part and one or more user configurable incentive offer container web parts. The general incentive offer container web part will receive and maintain all incentives offered by the retailer or products manufacturers available to all customers. The user configurable incentive offer container web parts will receive and maintain customized incentives to each individual customer. The system will automatically deliver incentive offers into the customer configured containers according to the web part settings and the customer's personal preference and lifestyle. A customer can have several user configurable incentive offer container web parts to manage different incentive offers. Incentive offers in any type of containers may be automatically removed from the containers once they are expired unless they are marked to keep by the customer.

Furthermore, the system provides at least one loyalty rewards web part. This web part presents a summary of a customer's accumulated reward points, if applicable, and achieved levels. Additional information can be displayed, like the points needed for certain redeemable items which can motivate customers to spend more. A customer can also review used points, rewards history, redeemed items, and other related information.

Furthermore, the system provides at least one shopping planner web part. Multiple shopping planner web parts may be provided to suit customers' different shopping styles. Each web part may contain several templates for making shopping plans. Each shopping planner web part provides at least 3 alternative shopping list building templates: (a) A regular shopping list template which lists all regular consumable products a family would purchase (products in this list may be purchased at different frequencies, customers can set the time intervals for the system to remind for shopping a particular product); (b) a reminder list template which records specific products needed to be purchased on next shopping trip (such as salt or trash bags which are not purchased weekly but they need to be purchased when they are about to run out); and (c) a current shopping list template which lists all products to be purchased at next store shopping trip or online order. Customers can customize each template and save it as individual shopping lists for their convenience. The templates and the shopping lists are version controlled. However, the customers may only view the last version of the saved templates or shopping lists. Customers can set product purchase frequency and reminders in the regular shopping list and the reminder list. The system will automatically add the planned shopping products into the current shopping list when a customer starts to view or build a current shopping list. For each product, the source list name can be marked for the convenience of making purchase plan.

The current shopping list will communicate with shopping budget web parts to check if spending is over budget. The current shopping list can further communicate with the customer's nutrition and health management web parts to ensure planned purchase products will meet the customer or the customer's family health needs. It can further communicate with coupon box web parts, incentive container web parts, rewards container web parts to match available coupons, incentives, and rewards with products in the shopping list. Customers can redeem the available coupons, incentives, and rewards from the shopping list online.

Each shopping planner web part provides a number of current shopping list building tools. Customers can select how a current shopping list to be built, such as from (a) scratch, (b) last purchased list, (c) regular shopping list, (d) reminder list, (e) last saved current list, and (f) system suggested shopping list. The system suggested shopping list will be generated by the system according to a customer's product purchase preference profile. Customers can add or remove items from any of the shopping lists to build a shopping list they want to use for the next shopping trip. The system will provide intelligent tools to help customer update or modify the current shopping list. The system can provide suggestions or alternative choices for the customer during shopping list development, like offering up-sale, down-sale, cross-sales, needed products from a recipe, and substituted products in promotion.

Furthermore, the system provides at least one shopping budget web part. Several styles of shopping budget web parts may be provided to meet customers' needs. Customers can choose any styles of web parts according to his or her personal preference. Shopping budget web parts provide tools for reviewing transactions of past purchases, summarizing actual spending by customer defined format, projecting future spending based on the customers' current shopping pattern. Customers can set budget allocations for each type of product or each group of products. For example, a customer can set spending for cookies not to exceed 5% of total grocery spending to control children's diet. The shopping budget web parts can alert customers if a customer's spending is out of the norm. In addition, in order to meet the needs of customer online shopping and fast checkout in in-store shopping, retail store can provide cash account services for customers. This can be done through a partnership with a service bank. Customer may opt to open a store account and transfer funds to the customer's account for automatic payment of online shopping or fast checkout at any retail stores.

Furthermore, the system provides at least one nutrition and health management web part. Multiple nutrition and health management web parts may be provided to meet different customer needs. Customers can choose one or more of the web parts to manage different nutrition and health programs for different family members. Customers can use publically available health guidelines for family nutrition and health management. In addition, customers can set special nutrition and health requirements to control family nutrition balance and health. The web parts will integrate the recently purchased food, planned purchase food, and nutrition data to alert the customers of overtaken or undertaken nutrition. Such integration is achieved through data connection among web parts. Relevant data are stored in the system data storage databases.

Furthermore, the system provides at least one online shopping web part. Different styles of online shopping web parts will be provided. The online shopping web parts provide necessary functionalities for online shopping transactions with the retail store or its alliance. A customer can configure each shopping web part for a dedicated shopping task. Customers can choose how and when an order is to be fulfilled, such as placing an order as home delivery, in-store pick up, outside store curb pick up, or parking lot pick up.

Furthermore, the system provides at least one general advertising web part and one or more user configurable advertising web parts. The advertising web parts may present any type of multimedia, like digital movies, slide shows, banner, or images. In order to allow advertisement to reach all customers, the general advertising web parts may not be removed from a web page or closed completely by customers. However, it may allow customers to minimize the general advertising web parts or turn off the sound if applicable. More flexibility can be allowed for user configurable advertising web parts, such as customers can add or remove any of the customer configurable advertising web parts. Customers can configure a web part to receive and play only certain types of advertisements. Only customer selected types of advertisements will be delivered to the customer configured web parts. This empowers customers to be total control over the advertisement contents. As a result, customers may more appreciate the advertisements. More effective targeted advertisements can be delivered.

Furthermore, the system provides one general event planning web part and one or more user configurable event planning web parts. In the general event planning web part, users can schedule all events or activities, and set up automatic alarm when the events or activities are coming closer. A family can have one general event planning web part and several personalized event planning web parts. The system will merge the events in the personalized event planning web parts into the general web part to check if there are any conflicts in scheduling. In a reversed process, customers can build schedules in the general event planning web part and distribute each event to personalized individual web parts. The system will automatically distribute the events into personalized event planning web parts. Customers can set workflows to specify how an event is to be completed and assign tasks to invited participants. The event organizer can send the schedule to invited participants. The event organizer can request sponsorship by sending an event plan to selected potential sponsors within the system for raising money or getting discount offers. A list of sponsors will be available to the customers within the event planning web parts.

Furthermore, the system provides one or more alert web parts. Each alert web part is user configurable. Customers can configure communication channels to have different alerts delivered through different channels. Customers can choose to have an alert delivered by text message, cell phone call, landline phone call, email, message board, or a combination of these channels according to the nature and level of an alert.

Furthermore, the system provides multiple special interests web parts. Special interests may include nutrition guide, product information, do-it-yourself instructions, cooking instruction and contests, clubs, and other special interests. Customers can select and load their favorite web parts into their personalized pages. A retail store may provide a variety of promotional and educational activities to customers through the special interests web parts. The activities can be in any form, including live video webcasting, scheduled webcasting, videos, slide shows, online contests, video training materials, and interactive training materials. The activities or materials may be grouped according to their natures and delivered to customers by special interests groups. Content delivery can be further adjusted according to individual customer's preference. The special interests web parts may include at least the following web parts: (1) one product introduction movie web part, (2) one food movie web part, (3) one health web part, (4) one nutrition web part, (5) one sports web part, (6) one book suggestions (or club) web part, (7) one how do-it-yourself web part, (8) one cooking contest web part, and (9) one arts and crafts web part. Other web parts promoting special interests may also be added to attract customers with different interests.

In order to encourage more customers to participate in store sponsored activities, it is necessary to allow customers to upload their favorite materials onto the system and share with others. For this purpose, the system provides at least one document upload web part. Customers can upload pictures, video clips, or any digital files onto the system to share with other customers, or any users on the system. The system will save the uploaded files at a location corresponding to a special interests web part or at locations a customer selected. The system will display or make a file available online based on the file creator's specification or based on customer's special interests groups.

Furthermore, the system provides at least one content search web part. Multiple web parts for different search methods may be provided. These web parts can provide different search engines to help customers to find information quickly, such as by key word search, visual search, topic search, and content search. Customers can configure their pages to have one or more search web parts available to them. Such search engines are available commercially or for free.

Furthermore, the system provides one general contact web part and one or more user configurable contact web parts. General contact web part may list all available contact names and associated information. Customers, retailers, products manufacturers, and service providers may have the choice to be listed in the general contact web part. User configurable contact web parts can list customer preferred contacts. Customers can use several contact web parts to organize different contacts, like family contacts, work contacts, and social activities contacts. Customers can group their contacts for different communication needs. Customers can select to participate in certain social contact groups in order to gain information from those groups.

Furthermore, the system provides one general message web part and one or more user configurable message web parts. Customers may choose to have several user message web parts in one or more pages and configure each web part to receive and display messages from predefined message sources. Messages sent to a customer will be automatically sorted and deposited into the customer configured message web parts according to the settings of the web parts. The general message web part will display all communications relevant to all customers. This feature is necessary for the retailer to distribute certain information to all customers.

Furthermore, the system provides at least one discussion web part. Customers can select to join in one or more discussion groups. Customers can use several discussion web parts and configure each for different discussion groups.

While particular embodiments of the present invention have been described, it would be obvious to those skilled in the art that various other changes and modifications can be made without departing from the spirit and scope of the invention.

What is claimed is:

1. A system for improving retail store customer loyalty comprising : (a) a plurality of coupon box web parts, (b) a plurality of incentive offer container web parts, (c) a plurality of rewards container web parts, (d) a plurality of shopping planner web parts, (e) a store map web part, (f) a plurality of online shopping web parts, (g) a plurality of advertising web parts, (h) a plurality of shopping budget web parts, (i) a plurality of family nutrition and health management web parts, (j) a plurality of event planning web parts, (k) a plurality of alert web parts, (l) a plurality of special interests web parts, (m) a document upload web part, (n) a plurality of content search map web parts, (o) a plurality of contact web parts, and (p) a plurality of message web parts, whereby retailers, product suppliers, and service providers can share resources to communicate with customers directly and to provide customized products and services to improve customer shopping experience, and in turn to improve customer loyalty.

2. The system of claim 1, wherein said web parts are delivered to customers through World Wide Web pages through interne.

3. The system of claim 1, wherein said web parts are user selectable and user configurable, whereby customers can freely add, remove, and configure said web parts to satisfy personal preferences.

4. The system of claim 1, wherein said web parts provide means for allowing customers to set up passwords or keys for accessing said web parts.

5. The system of claim 1, wherein further comprising a customer product purchase preference data analysis system.

6. The system of claim 5, wherein said customer product purchase preference data analysis system comprises: (a) means for extracting customer purchased products data, (b) means for extracting information of customer planned shopping products in customer's shopping lists, (c) means for extracting customer responses to product and incentive offers, (d) means for extract information related to customer's web part selections and web part settings, (d) means for analyzing customer shopping behavior data, (e) means for analyzing customer product purchase preferences, (f) means for constructing customer product purchase preference profiles, (g) means for recommending relevant products and services to customers while customers are building shopping lists, and (h) means for recommending relevant advertisements to customers while customers are using said system.

7. The system of claim 5, wherein said customer product purchase preference data analysis system comprises a plurality of stored procedures stored in the system database server.

8. The system of claim 1, wherein further comprising a user configurable visual interface that provides means for allowing users to customize or personalize their interfaces through adding, removing, rearranging, and configuring elements inside said user configurable visual interface.

9. The system of claim 1, wherein further comprising a short message service enabled user interface that provides means for allowing customers to call in to search product information and retrieve shopping lists and reminders by text massages.

10. The system of claim 1, wherein further comprising a voice enabled user interface that provides means for (a) searching products and product shelf locations, (b) retrieving shopping lists, and (c) retrieving reminders by voice, whereby customers can call in by landline phones, cell phones, or other mobile devices to search for products and product shelf locations to get instant help during in-store shopping.

11. A method of assisting customers building shopping lists comprising: (a) providing said customers a plurality of shopping list templates through user configurable shopping planner web parts, (b) providing means for allowing said customers to build shopping lists from said templates and save said shopping lists, (c) providing means for allowing said customers to set product purchase frequency and reminders, and (d) providing product recommendations to said customers while said customers are building their shopping lists.

12. The method of claim 11, wherein said shopping list templates comprise: (a) a regular shopping list template for allowing customers to list regularly needed products and save the modified templates as regular shopping lists, (b) a reminder list template for allowing said customers to record specific items that need to be purchased in the next shopping trip, and (c) a current shopping list template for allowing said customers to list all items to be purchased during the next in-store shopping trip or online ordering.

13. The method of claim 11, wherein said product recommendations are based on one or more of the conditions: (a) the products in a customer's shopping list, (b) the products input by the customer during shopping list building, (c) previously purchased products by the customer, and (d) the product preference profile of the customer.

14. The method of claim 11, further comprising providing means for facilitating communications among shopping planner web parts, coupon box web parts, incentive container web parts, rewards container web parts, shopping budget web parts, and family nutrition and health management web parts to check if spending of certain categories of products are over budgets, to ensure planned purchase will meet said customer's or the household's health needs, and to match available coupons, incentives, and rewards with products in the shopping list.

15. A method of constructing a customer's product purchase preference profile comprising the steps of: (a) defining multi-dimensional metrics presenting product price level, customer lifestyle, and product purchase decision making behavior; (b) defining a scale for each dimension of said metrics; (c) assigning a score for each level of said scale; (d) assigning scores for each dimension of each product, each customer preference setting parameter, and each customer product purchase decision making behavior based on predefined rules; (e) building a multi-dimensional metric data set corresponding to said multi-dimensional metrics for each customer according to customer's purchased products, web part settings, and product purchase decision making behavior, (e) adding the scores of each product, each customer preference setting parameter, and each customer product purchase decision making behavior to each corresponding dimensions of said multi-dimensional metric data set, and finally (f) averaging the scores of each dimension of the data set for said customer, (g) saving the average scores of each dimension of said multi-dimensional metric data set as said customer's product purchase preference profile.

16. The method of claim 15, wherein said product purchase decision making behaviors comprise: (a) responding to online offers in the forms of a product, a coupon, a promotion, an incentive, or an advertisement, (b) selecting products during shopping list building; and (c) making the actual product purchase in comparison to planned purchase.

17. A method of assisting a customer to locate shelf locations of products during in-store shopping comprising providing one of the following instructions: (a) a store map visually displaying said shelf locations of products in said customer's shopping list, (b) text messages listing said shelf locations of products in said customer's shopping list, and (c) voice messages narrating said shelf locations of products in said customer's shopping list, said instructions being delivered to said customer based on the connection type initiated by the requesting device used by said customer.

18. The method of claim 17, further comprising providing means for allowing said customer to search products and their shelf locations by means of internet web pages, text messages, or voice messages, whereby said customer can search products and their shelf locations by a store provided kiosk or a personal mobile communication device.

19. A method of delivering customized coupons to a customer's coupon boxes comprising: (1) providing each customer one or more coupon boxes; (2) providing means for allowing said customer to set personal preferences in said coupon boxes; and (3) delivering relevant coupons to said coupon boxes according to said customer's coupon box settings and said customer's product purchase preference profile, (4) providing means for allowing said customer to select, sort, redeem, and delete said coupons online, and (5) deleting expired coupons from said customer's coupon boxes according to said customer's coupon boxes settings.

20. The method of claim 19, wherein said coupon boxes are provided to said customer through coupon box web parts.
